(19) United States
(12) Patent Application Publication
(10) Pub. No.: US 2020/0413089 A1
(43) Pub. Date: Dec. 31, 2020

(54) METHOD AND SYSTEM FOR MOTION REFINEMENT IN VIDEO CODING

(71) Applicant: ALIBABA GROUP HOLDING LIMITED, George Town (KY)

(72) Inventors: Ruling LIAO, San Mateo, CA (US); Yan YE, San Mateo, CA (US); Jie CHEN, San Mateo, CA (US)

(21) Appl. No.: 16/880,224

(22) Filed: May 21, 2020

Related U.S. Application Data
(60) Provisional application No. 62/866,042, filed on Jun. 25, 2019.

(51) Int. Cl. H04N 19/513; H04N 19/176; H04N 19/577; H04N 19/107; H04N 19/139

(52) U.S. Cl. CPC H04N 19/521; H04N 19/176; H04N 19/139; H04N 19/107; H04N 19/577

(57) ABSTRACT

The present disclosure provides systems and methods for motion refinement in video coding. The method can include: receiving a bitstream comprising a target image block; and enabling or disabling decoder side motion vector refinement (DMVR) for the target image block, wherein the enabling or disabling is based on at least one of: a flag signaled in the bitstream, or whether the DMVR is enabled or disabled for a neighboring block of the target image block.

### CROSS REFERENCE TO RELATED APPLICATION

The disclosure claims the benefit of priority to U.S. Provisional Application No. 62/866,042, filed Jun. 25, 2019, which is incorporated herein by reference in its entirety.

### TECHNICAL FIELD

The present disclosure generally relates to video processing, and more particularly, to methods and systems for performing motion refinement, such as decoder side vector refinement (DMVR).

### BACKGROUND

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

### SUMMARY OF THE DISCLOSURE

Embodiments of the present disclosure provide a method for processing video content. The method includes: receiving a bitstream comprising a target image block; and enabling or disabling decoder side motion vector refinement (DMVR) for the target image block, wherein the enabling or disabling is based on at least one of: a flag signaled in the bitstream, or whether the DMVR is enabled or disabled for a neighboring block of the target image block.

Embodiments of the present disclosure provide a system for processing video content. The system can include: a memory for storing a set of instructions; and at least one processor configured to execute the set of instructions to cause the system to: receive a bitstream comprising a target image block; and enable or disable decoder side motion vector refinement (DMVR) for the target image block, wherein the enabling or disabling is based on at least one of: a flag signaled in the bitstream, or whether the DMVR is enabled or disabled for a neighboring block of the target image block.

Embodiments of the present disclosure also provide a non-transitory computer readable medium that stores a set of instructions that is executable by at least one processor of a computer system to cause the computer system to perform a method for processing video content. The method can include: receiving a bitstream comprising a target image block; and enabling or disabling decoder side motion vector refinement (DMVR) for the target image block, wherein the enabling or disabling is based on at least one of: a flag signaled in the bitstream, or whether the DMVR is enabled or disabled for a neighboring block of the target image block.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an example video sequence, according to embodiments of this disclosure.

FIG. 2A illustrates a schematic diagram of an example encoding process, according to embodiments of this disclosure.

FIG. 2B illustrates a schematic diagram of another example encoding process, according to embodiments of this disclosure.

FIG. 3A illustrates a schematic diagram of an example decoding process, according to embodiments of this disclosure.

FIG. 3B illustrates a schematic diagram of another example decoding process, according to embodiments of this disclosure.

FIG. 4 illustrates a block diagram of an example apparatus for encoding or decoding a video, according to embodiments of this disclosure.

FIG. 5 illustrates a schematic diagram of Decoder Side Motion Vector Refinement (DMVR), according to embodiments of the disclosure.

FIG. 6 illustrates an exemplary DMVR searching procedure, according to embodiments of the disclosure.

FIG. 7 illustrates an exemplary DMVR Integer luma sample searching pattern, according to embodiments of the disclosure.

FIG. 8 illustrates an exemplary DMVR integer sample offset search stage, according to embodiments of the disclosure.

FIG. 9 illustrates an exemplary DMVR parametric error surface estimation, according to embodiments of the disclosure.

FIG. 10 illustrates an exemplary merge data syntax structure, according to embodiments of the disclosure.

FIG. 11 illustrates another exemplary merge data syntax structure, according to embodiments of the disclosure.

FIG. 12 illustrates another exemplary merge data syntax structure, according to embodiments of the disclosure.

FIG. 13 illustrates another exemplary merge data syntax structure, according to embodiments of the disclosure.

FIG. 14 illustrates an exemplary converted bi-prediction merge candidate, according to embodiments of the disclosure.

FIG. 15 illustrates an exemplary converted bi-prediction merge candidate, according to embodiments of the disclosure.

FIG. 16 illustrates another exemplary merge data syntax structure, according to embodiments of the disclosure.

FIG. 17 illustrates an exemplary inherited DMVR decision for regular merge mode, according to embodiments of the disclosure.

FIG. 18 illustrates an exemplary opposite DMVR decision when oppo_dmvr_flag=1, according to embodiments of the disclosure.

FIG. 19 illustrates another exemplary merge data syntax structure, according to embodiments of the disclosure.

FIG. 20 illustrates an exemplary coding unit syntax structure, according to embodiments of the disclosure.

FIG. 21 illustrates another exemplary coding unit syntax structure, according to embodiments of the disclosure.

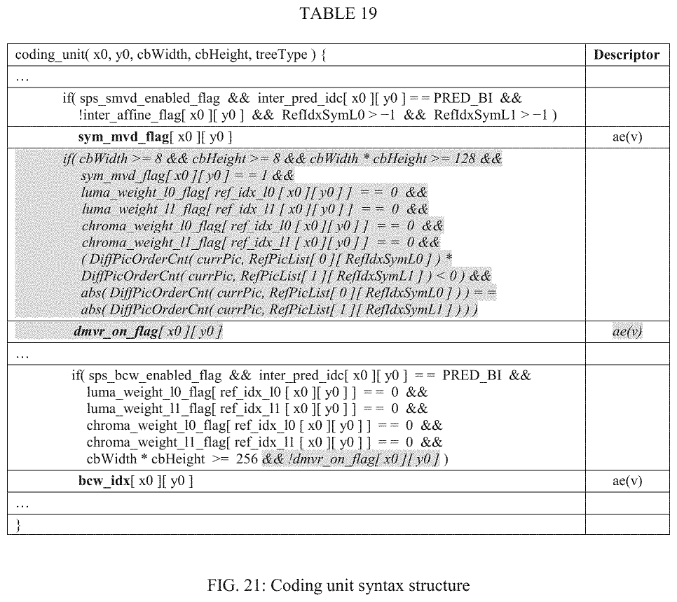

FIG. 22 illustrates another exemplary coding unit syntax structure, according to embodiments of the disclosure.

FIG. 23 illustrates another exemplary coding unit syntax structure, according to embodiments of the disclosure.

FIG. 24 illustrates a flowchart of an exemplary method for processing video content, according to embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for monitoring, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture coded using a previous picture as a reference picture is referred to as a “P-picture.” A picture coded using both a previous picture and a future picture as reference pictures (i.e., the reference is “bi-directional”) is referred to as a “B-picture.” The present disclosure relates to techniques for predicting the B-pictures.

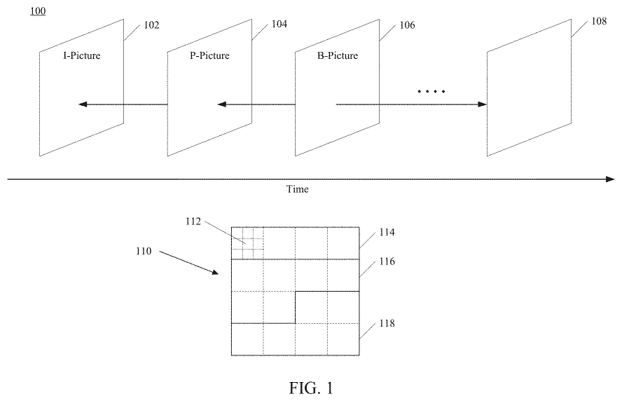

FIG. 1 illustrates structures of an example video sequence 100, according to some embodiments of this disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and this disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in this disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

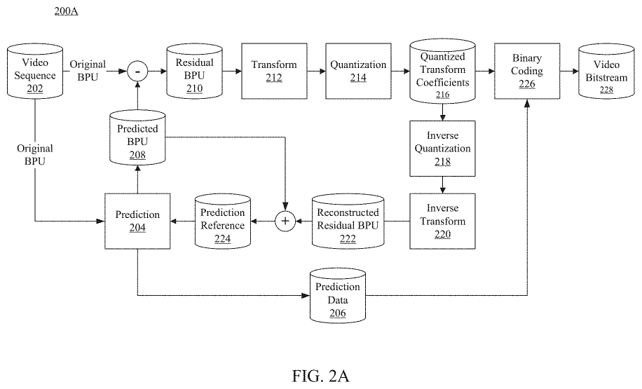

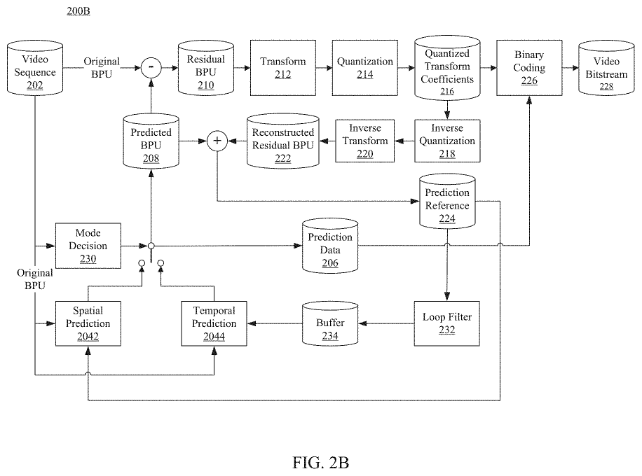

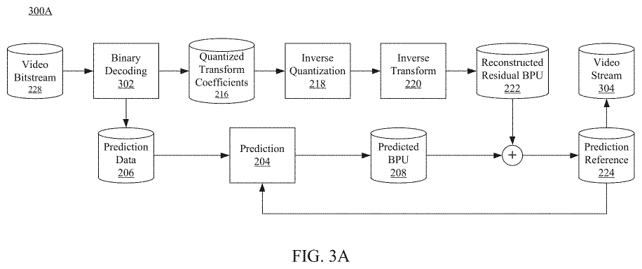

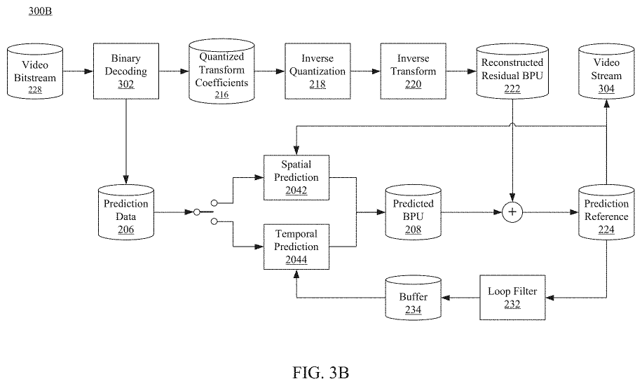

Video coding has multiple stages of operations, examples of which will be detailed in FIGS. 2A-2B and 3A-3B. For each stage, the size of the basic processing units can still be too large for processing, and thus can be further divided into segments referred to as “basic processing sub-units” in this disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which will be detailed in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which will be detailed in FIG. 2A), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which will be detailed in FIG. 2A), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and this disclosure does not limit embodiments thereof.

FIG. 2A illustrates a schematic diagram of an example encoding process 200A, according to some embodiments of this disclosure. An encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., grayscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, according to some embodiments of this disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (i.e., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), the encoder can feed prediction reference 224 to loop filter stage 232, at which the encoder can apply a loop filter to prediction reference 224 to reduce or eliminate distortion (e.g., blocking artifacts) introduced by the inter prediction. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, according to some embodiments of this disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, according to some embodiments of this disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the encoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, when the prediction mode indicator of prediction data 206 indicates that inter prediction was used to encode the current BPU, prediction data can further include parameters of the loop filter (e.g., a loop filter strength).

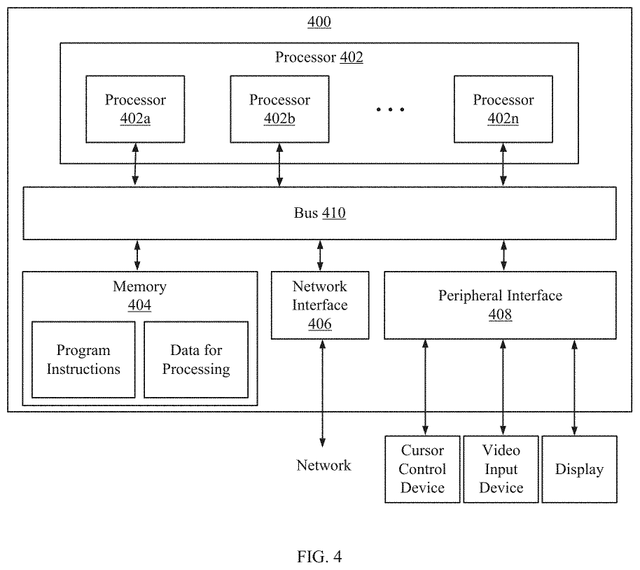

FIG. 4 is a block diagram of an example apparatus 400 for encoding or decoding a video, according to some embodiments of this disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

In some embodiments, to increase the accuracy of the motion vectors (MVs) of a merge mode, a bilateral-matching (BM) based decoder side motion vector refinement (DMVR) can be applied.

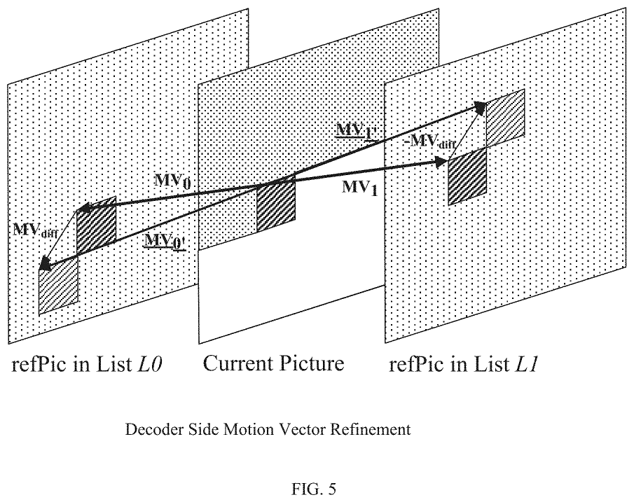

For example, in bi-prediction operation, a refined motion vector (MV) can be searched around the initial MVs in the reference picture list L0 and reference picture list L1. The BM method calculates the distortion between the two candidate prediction blocks in the reference picture list L0 and list L1. As illustrated in FIG. 5, the sum of absolute difference (SAD) between the empty blocks based on each MV candidate around the initial MV can be calculated. The MV candidate with the lowest SAD becomes the refined MV and is used to generate the bi-predicted signal.

In VVC draft 5, the DMVR can be applied to the CUs which satisfy all of the following conditions:
CU level merge mode with bi-prediction MV or combined inter and intra prediction mode (in this case DMVR is applied to the inter part of the CIIP mode)
The block is predicted using bi-prediction motion vector with equal weights. That is, bi-prediction with weighted averaging (BWA) is not applied to the block
One reference picture is in the past and another reference picture is in the future with respect to the current picture
The distances (e.g., picture order count (POC) differences) from both reference pictures to the current picture are the same
The block has at least 128 luma samples and the block width and height are both larger than or equal to 8 luma samples

It is noted that in VVC draft 9, the DMVR cannot be applied to combined inter and intra prediction mode.

The refined MV derived by DMVR process can be used to generate the inter prediction samples and also used in temporal motion vector prediction for coding of future pictures, while the original MV is used in deblocking process and also used in spatial motion vector prediction for future CU coding within the current picture.

The additional features of VVC draft 5 DMVR will be discussed next.

As an initial matter, searching scheme of DMVR will be discussed.

As shown in FIG. 5, the search points surround the initial MV and the MV offset obey the MV difference mirroring rule. In other words, any points that are checked by DMVR, denoted by candidate MV pair (MV0, MV1) obey the following two equations:

MV0′=MV0+MV_offset (1)

MV1′=MV1−MV_offset (2)

In the above equations, MV_offset represents the refinement offset between the initial MV and the refined MVs. Note that MV_offset is a vector with motion displacements in the X and Y dimensions. In VVC draft 5, the refinement search range is two integer luma samples from the initial MV in both horizontal and vertical dimensions.

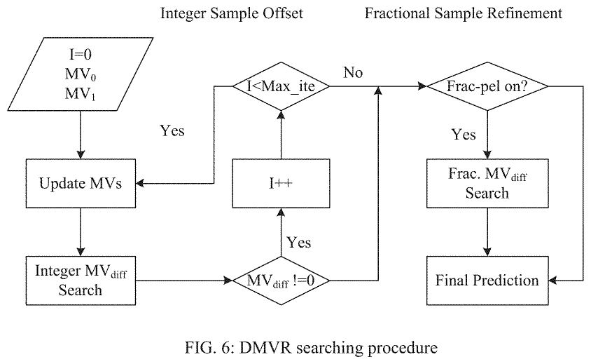

FIG. 6 illustrates an example of the searching process of DMVR in VVC draft 4. As shown in FIG. 6, the searching includes the integer sample offset search stage and fractional sample refinement stage. To reduce the search complexity, a fast searching method with early termination mechanism is applied in the integer sample offset search stage. Instead of 25 points full search, a 2-iteration search scheme is applied to reduce the SAD checking points.

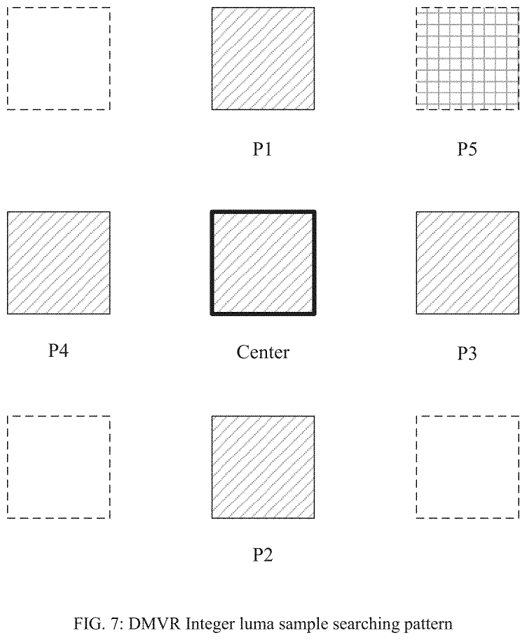

FIG. 7 illustrates an exemplary DMVR Integer luma sample searching pattern, according to embodiments of the disclosure. As shown in FIG. 7, a maximum of 6 SADs are checked in the first iteration. First, the SAD of the five points (e.g., Center and P1˜P4) are compared. If the SAD of the center position is smallest, the integer sample stage of DMVR is terminated. Otherwise another position P5, which is determined by the SAD distribution of P1˜P4, can be checked. Then, among P1˜P5, the position with smallest SAD is selected as center position of the second iteration search. The process of the second iteration search is same as that of the first iteration search. The SAD calculated in the first iteration can be re-used in the second iteration. Therefore, only SAD of 3 additional points needs to be further calculated. The integer sample search may be followed by fractional sample refinement. To save computational complexity, the fractional sample refinement is derived using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied in VVC draft 4.

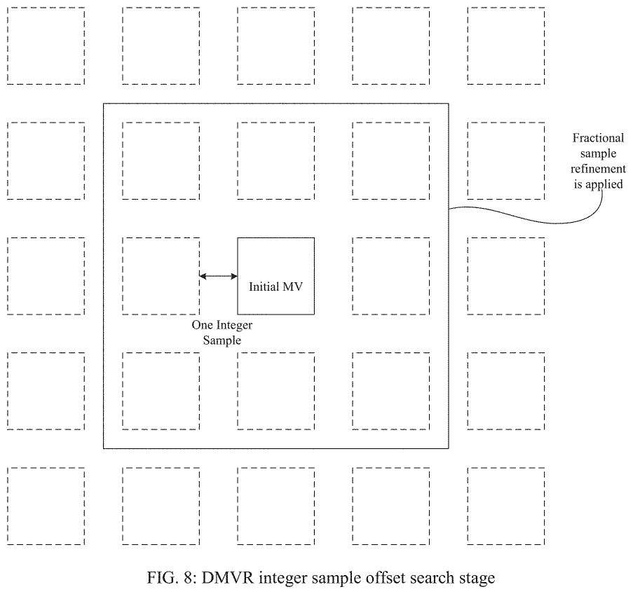

In VVC draft 5, the 2-iteration search is removed. Instead, in the integer sample search stage, all the SAD of 25 points are calculated, as shown in FIG. 8. Then the position with smallest SAD may be further refined in fractional sample refinement stage. The fractional sample refinement is conditionally invoked based on the position with the smallest SAD. If the position is one of nine points around initial MV as depicted in FIG. 8, the fractional sample refinement is further applied, and the refined MV is the output of this searching process. Otherwise, the integer position with the smallest SAD is directly used as the output of this searching process.

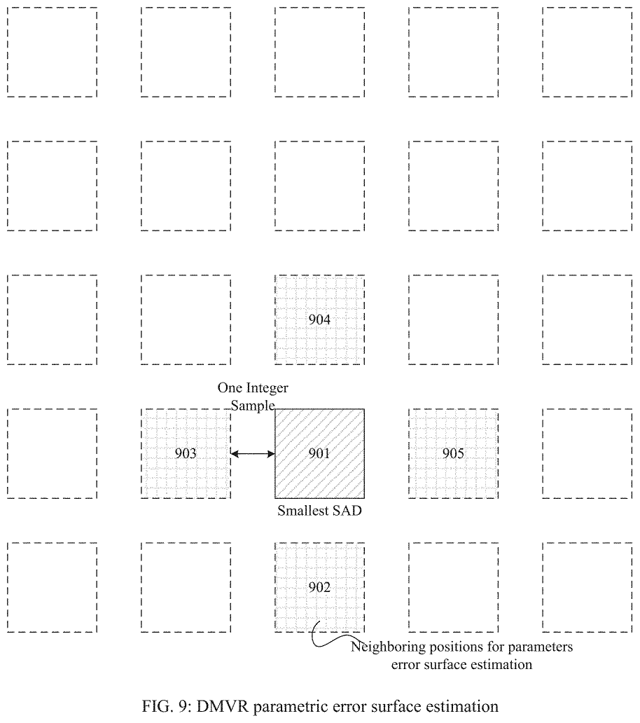

In parametric error surface based sub-pixel offsets estimation, as shown in FIG. 9, the center position cost and the costs at four neighboring positions from the center are used to fit a 2-D parabolic error surface equation of the following form.

E(x,y)=((A(x−xₘᵢₙ)²+B(y−yₘᵢₙ)²+)>>mvShift)+E(0,0) (3)

In the above equation (3), (xₘᵢₙ, yₘᵢₙ) corresponds to the fractional position with the least cost and E(x, y) corresponds to the cost of center and four neighboring positions, mvShift is set to 4 in VVC draft 5 (in VVC draft 5, MV accuracy is 1/16-pel), and the value A and B are set as follows:

$$\begin{matrix}A = \frac{E ( - 1 , 0 ) + E ( 1 , 0 ) - 2 E ( 0 , 0 )}{2} & ( 4 ) \\ B = \frac{E ( 0 , - 1 ) + E ( 0 , 1 ) - 2 E ( 0 , 0 )}{2} & ( 5 )\end{matrix}$$

By solving the above equations (4) and (5) by using the cost value of the five search points, the (xₘᵢₙ, yₘᵢₙ) is computed as:

xₘᵢₙ=((E(−1,0)−E(1,0))<<mvShift)/(2(E(−1,0)+E(1,0)−2E(0,0))) (6)

yₘᵢₙ=((E(0,−1)−E(0,1))<<mvShift)/(2((E(0,−1)+E(0,1)−2E(0,0))) (7)

The value of xₘᵢₙ and yₘᵢₙ are automatically constrained to be between −8 and 8 (in 1/16 sample precision) since all cost values are positive and the smallest value is E(0,0). This corresponds to half-pel offset with 1/16^{th}-pel MV accuracy in VVC draft 5. The computed fractional (xₘᵢₙ, yₘᵢₙ) are added to the integer distance refinement MV to get the refinement MV with sub-pel accuracy.

Bilinear-interpolation and sample padding will be discussed below.

In VVC, the resolution of the MVs is 1/16 luma samples. The samples at the fractional position are interpolated using an 8-tap interpolation filter for motion compensated prediction. In DMVR, the search points surround the initial MV with integer sample offset. Because the initial MV may have fractional-pel accuracy, the samples of those fractional position can be interpolated during the DMVR search process. To reduce the computation complexity, the bilinear interpolation filter is used to generate the fractional samples for the searching process in DMVR. Another important effect is that by using bilinear filter is that with 2-sample search range, the DMVR does not access more reference samples compared to the normal motion compensation process. After the refined MV is obtained with DMVR search process, the normal 8-tap interpolation filter is applied to generate the final prediction. In order to not access more reference samples than normal MC process, any samples not needed for the interpolation process based on the original MV but needed for the interpolation process based on the refined MV will be padded from those available samples.

A Maximum DMVR processing unit will be discussed below.

When a CU is larger than 16 luma samples in either dimension, it will be further split into sub-blocks with width and/or height equal to 16 luma samples. If a CU is 16×8 and 8×16 luma samples in size, no further splitting is performed. This guarantees that the maximum unit size for DMVR searching process is limited to 16×16.

A symmetric motion vector difference mode will be discussed below.

In VVC draft 5, a symmetric motion vector difference (SMVD) mode is adopted to improve the coding efficiency of bi-prediction inter mode. In the SMVD mode, the motion vector differences (MVD) of L0 and L1 motion vectors obey the mirroring rule. That is, the motion vectors of a block predicted using SMVD mode obey the following equations:

MV0=MVP0+MVD (8)

MV1=MVP1−MVD (9)

In the above equations, MV0 and MV1 represent the two motion vectors of the block, MVP0 and MVP1 are the motion vector predictors for MV0 and MV1, respectively. And, MVD is the motion vector difference for L0 direction.

Besides, the reference pictures of two motion vectors are not signaled but derived at a slice or tile level. Denote RefIdxSymL0 and RefIdxSymL1 as two reference indices in reference picture list 0 and list 1 for SMVD mode. The two reference indices are derived using the following rules:
a) The forward reference picture in reference picture list 0, which is nearest to current picture, is searched. If found, RefIdxSymL0 is set equal to the reference index of the forward picture.
b) The backward reference picture in reference picture list 1, which is nearest to current picture, is searched. If found, RefIdxSymL1 is set equal to the reference index of the backward picture.
c) If both forward and backward pictures are found, the process is completed.
d) Otherwise, the following applies:
   i) The backward reference picture in reference picture list 0, which is nearest to current, is searched. If found, RefIdxSymL0 is set equal to the reference index of the backward picture.
   ii) The forward reference picture in reference picture list 1, which is nearest to current picture, is searched. If found, RefIdxSymL1 is set equal to the reference index of the forward picture.
   iii) If both backward and forward pictures are found, the process is completed.
   iv) Otherwise, the SMVD mode is marked as nonavailable.

Next, some problems associated with applying the DMVR process are described.

As explained earlier, the DMVR process calculates the distortion between the two candidate blocks in the reference picture list L0 and list L1, and the position with minimum distortion is used to generate the bi-prediction signal. Besides, the DMVR process is always applied to a block predicted using regular merge mode or combined inter and intra prediction mode (CIIP) when all the conditions mentioned earlier are satisfied. This design may be problematic in the following aspects.

In a first aspect, there is no flag at block level to disable DMVR process. In some cases, minimizing the SAD of two predictors cannot guarantee that the generated bi-prediction signal using the refined MV is the best predictor of the block. Therefore, applying DMVR process to the merge block may reduce the coding efficiency of merge mode.

In a second aspect, in the VVC draft 5, the motion information including weight index for BWA of a merge block is inherited from its neighboring block. However, the DMVR process is applied to the merge block once the conditions mentioned before are all satisfied. The decision of whether the DMVR process is applied to the neighboring block is no longer used for the current merge block. It may violate the design concept of inheriting all motion information from neighboring block in merge mode.

In a third aspect, the DMVR process aims to refine the MV accuracy. However, it is only applied to regular merge block but not AMVP (advanced motion vector prediction) or SMVD (symmetric motion vector difference) blocks. So the benefits of DMVR cannot be applied to AMVP and MMVD mode.

Next, some exemplary embodiments for enabling or disabling the DMVR process are described.

DMVR can be disabled for merge mode.

In some embodiments, a block level flag is signaled to indicate whether the DMVR process is applied to the merge block.

For example, one flag for regular merge mode and/or CIIP mode can be signaled to disable the DMVR process

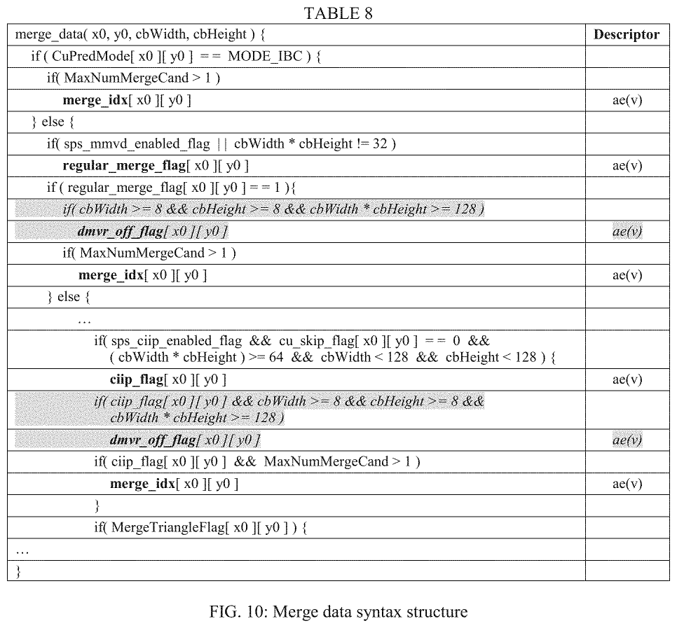

In some embodiments, a flag is sent together with merge index when a merge block is predicted using regular merge mode or CIIP mode. In one example, the flag is signaled prior to the merge index, as shown in Table 8 of FIG. 10 (emphasized in italics and gray). The syntax element “dmvr_off_flag” is used to indicate whether the DMVR process is applied to the merge block. When “dmvr_off_flag” is equal to 0, the DMVR process is applied to the merge block. Otherwise, the DMVR process is not applied to the merge block when “dmvr_off_flag” is equal to 1. When it is not present, the flag is inferred to be 0.

In this case, the DMVR process can be applied to the merge blocks, when the merge blocks satisfy all of the following conditions:
Regular merge mode with bi-prediction MV or combined inter and intra prediction mode (in this case DMVR is applied to the inter part of the CIIP mode)
The block is predicted using bi-prediction motion vector with equal weights. That is, bi-prediction with non-equal weights (BWA) is not applied to the block
One reference picture is in the past and another reference picture is in the future with respect to the current picture
The distances (e.g., POC difference) from both reference pictures to the current picture are same
The block has larger than or equal to 128 luma samples and the block width and height are both larger than or equal to 8 luma samples
The dmvr_off_flag is equal to 0

The last condition of the “dmvr_off_flag” being equal to 0 can be used to determine whether DMVR is enabled or not, and the other conditions are existing conditions in VVC draft 5. To a person skilled in the art, the last condition above can also be combined with any other conditions to determine whether DMVR is applied or not.

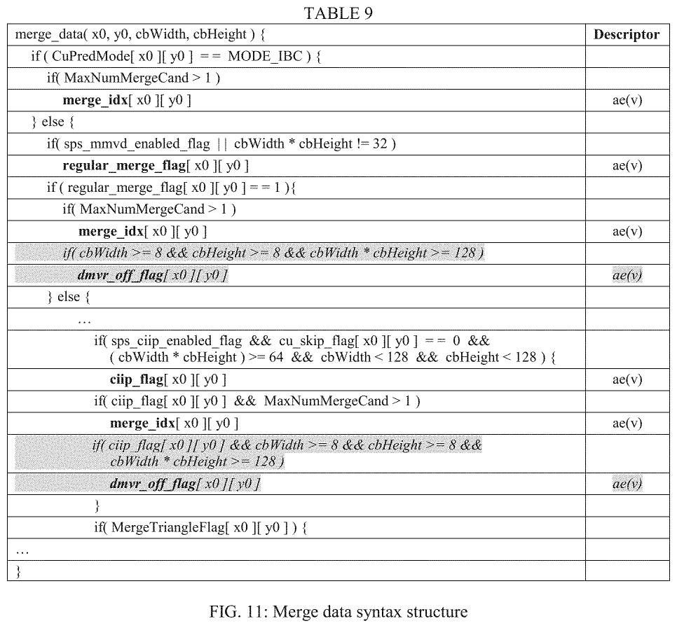

In some embodiments, the flag can be signaled after the merge index, as shown in Table 9 of FIG. 11 (emphasized in italics and gray).

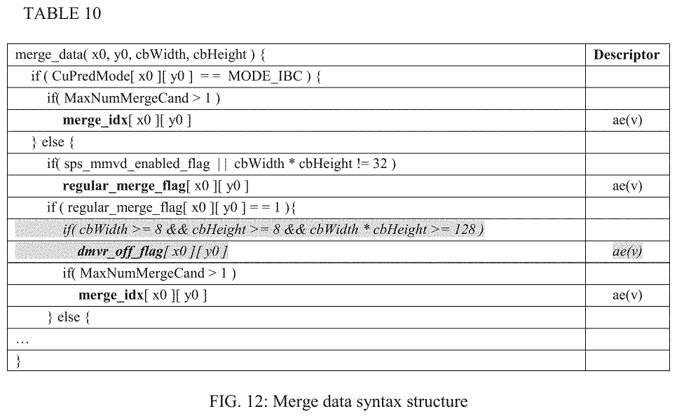

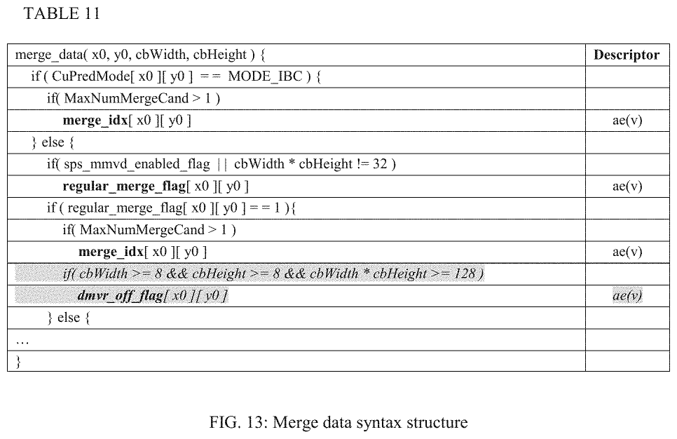

In some embodiments, the flag can be sent together with merge index when a block is predicted using regular merge mode but not CIIP mode, as shown in Table 10 of FIG. 12 and Table 11 of FIG. 13 (emphasized in italics and gray). When a block is predicted using the regular merge mode, “dmvr_off_flag” can be sent to indicate whether the DMVR process is applied to the block. When it is not present, the flag can be inferred to be 0 or 1. As an example, the “dmvr_off_flag” is inferred to be 0 for the CIIP mode. In other words, the DMVR process can be applied to a block predicted using the CIIP mode. As another example, the “dmvr_off_flag” can be inferred to be 1 for the CIIP mode. In other words, the DMVR process can be disabled for a block predicted using the CIIP mode.

The “dmvr_off_flag” can be signaled to turn off the DMVR process, when both the width and height of a merge block are larger than or equal to 8 and the block size is larger than or equal to 128. However, the signaling overhead of this flag of “dmvr_off_flag” can be “wasted” as the DMVR process is disabled for the merge block in the following cases:

1. The merge block is predicted using uni-prediction merge candidate;

2. The BWA mode is applied to the merge block; and

3. The distance from the L0 reference picture to the current picture and the distance from the L1 reference picture to the current picture are different.

Uni-to-bi conversion will be discussed below.

To avoid wasting the signaling overhead of the flag “dmvr_off_flag” when the selected merge candidate is a uni-prediction candidate, the meaning of the flag “dmvr_off_flag” is changed in this case. For example, the uni-prediction merge candidate is converted to a bi-prediction merge candidate when the “dmvr_off_flag” is equal to a first value (e.g., 1), and is kept as a uni-prediction candidate when “dmvr_off_flag” is equal to a second value (e.g., 0). As an example, when the uni-prediction merge candidate is converted to a bi-prediction merge candidate, the DMVR process is applied to the converted bi-prediction merge candidate. As another example, the DMVR process is not applied to the converted bi-prediction merge candidate.

Without loss of generality, assuming that the uni-prediction merge candidate is predicted from reference picture list 0 (L0).

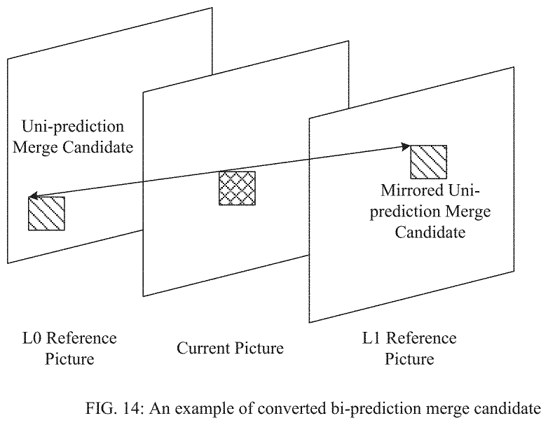

As an example, the L0 motion vector of the converted bi-prediction merge candidate is directly copied from the uni-prediction merge candidate. The L1 motion vector of the converted bi-predicted merge candidate is mirrored from the uni-prediction merge candidate, as shown in FIG. 14.

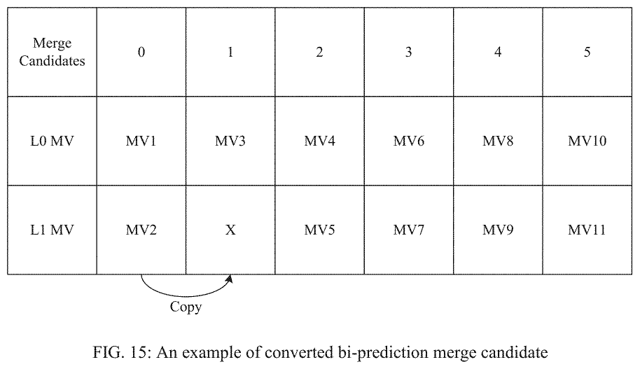

In another example, the L0 motion vector of the converted bi-prediction merge candidate is directly copied from the uni-prediction merge candidate. The L1 motion vector of the converted bi-predicted merge candidate is obtained from the first available L1 motion vector in the merge candidate list. As shown in the example in FIG. 15, the merge candidate 1 is uni-prediction. To convert it into bi-prediction, the L1 motion vector of the merge candidate 1 is copied from the L1 motion vector of the merge candidate 0.

In another example, the L0 motion vector of the converted bi-prediction merge candidate is directly copied from the uni-prediction merge candidate. The L1 motion vector of the converted bi-predicted merge candidate is obtained from the first available L1 motion vector in the merge candidate list whose corresponding L1 reference picture has the same distance to the current picture as that of the L0 reference picture to the current picture.

In another example, the L0 motion vector of the converted bi-prediction merge candidate is directly copied from the uni-prediction merge candidate. The L1 motion vector of the converted bi-predicted merge candidate is set to zero motion. The corresponding L1 reference picture is set to the closest reference picture in the reference picture list L1.

In another example, the L0 motion vector of the converted bi-prediction merge candidate is directly copied from the uni-prediction merge candidate. The L1 motion vector of the converted bi-predicted merge candidate is set to zero motion. The corresponding L1 reference picture is set to the first reference picture in the reference picture list L1.

Modification to Bi-prediction with weighted averaging will be discussed below.

To avoid wasting of the flag “dmvr_off_flag” in case BWA uses unequal weights, the weights of a bi-prediction merge candidate with BWA can be set to equal weights when the “dmvr_off_flag” is equal to 1. In other words, BWA can be disabled when “dmvr_off_flag” is equal to 1. Besides, the equal weights is used for inheritance for future block coding.

In some embodiments, one flag in merge mode can be signaled to disable the DMVR process.

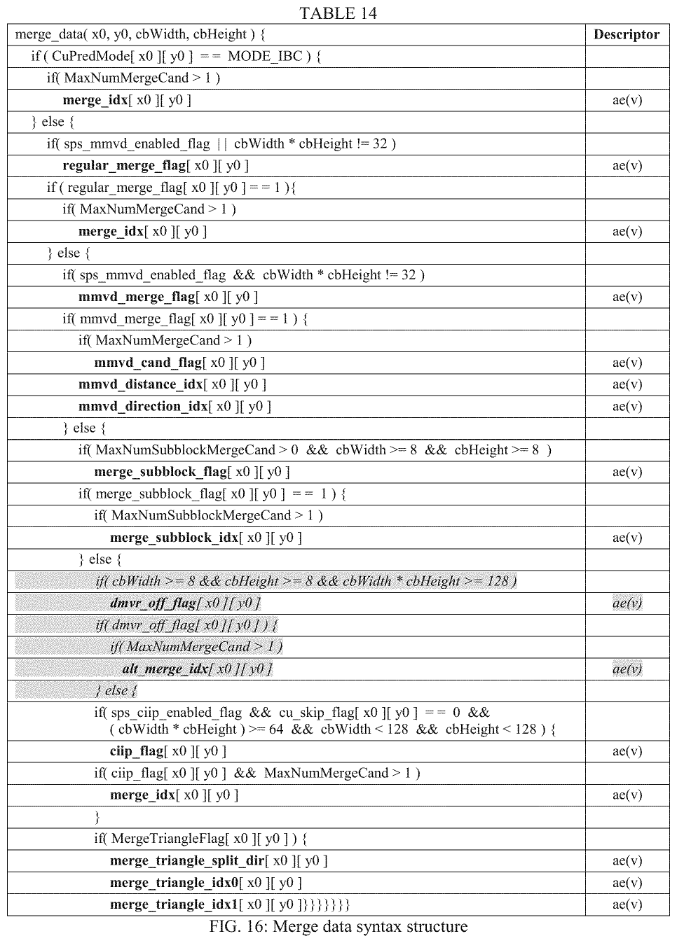

As an example, a flag can be signaled before CIIP mode, as shown in Table 14 of FIG. 16 (emphasized in italics and gray). The syntax element “dmvr_off_flag” can be sent to indicate that the DMVR process is not applied to the merge block. When the flag is on, one merge index (i.e., the syntax element “alt_merge_index”) is sent to indicate which merge candidate in a merge candidate list is used to predict the merge block. When the flag is not present, it is inferred to be 0.

In some embodiments, the flag “dmvr_off_flag” can be signaled before MMVD mode (e.g., the syntax element “mmvd_merge_flag” in Table 14), subblock merge mode (e.g., the syntax element “merge_subblock_flag” in Table 14) or triangle partition mode (e.g., the syntax element “MergeTriangleFlag” in Table 14).

When “dmvr_off_flag” is equal to 1, a merge index “alt_merge_idx” can be sent to indicate which merge candidate in a merge candidate list is used.

As an example, the merge candidate list is the same as the list used in the regular merge mode.

As another example, the alternative merge candidate list is derived from the list used in the regular merge mode by removing all the following merge candidates from the list used in the regular merge mode:

1. The merge block is predicted using uni-prediction merge candidate;

2. The BWA mode is applied to the merge block; and

3. The distances from the L0 and L1 reference pictures to the current picture are different.

As another example, the alternative merge candidate list is derived from the list used in the regular merge mode according to the following rules:

1. If the candidate is bi-prediction, the candidate is directly put into the merge candidate list;

2. Otherwise, the candidate is converted to bi-prediction if the candidate is uni-prediction.

As another example, the alternative merge candidate list is derived from the list used in the regular merge mode according to the following rules:

1. If the candidate is bi-prediction with BWA off, the candidate is directly put into the merge candidate list;

2. Otherwise, if the candidate is bi-prediction with BWA on, the candidate is put into the merge candidate list with BWA disabled; and

3. Otherwise, the candidate is converted to bi-prediction if the candidate is uni-prediction.

The DMVR decision for the regular merge mode and the CIIP mode can be inherited.

As mentioned before, the decision of whether the DMVR process can be applied to the neighboring block is no longer used for the current merge block. This violates the design concept of inheriting all motion information from neighboring block in merge mode. Therefore, in some embodiments, the decision of the DMVR process can be inferred from the neighboring block for the regular merge mode.

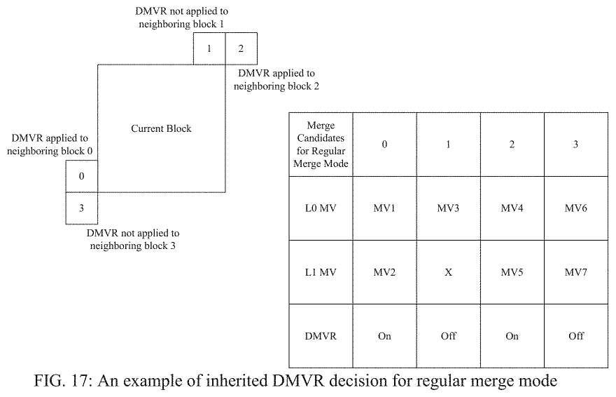

In some embodiments, the decision of whether the DMVR process is applied to a current block predicted using the regular merge mode is inferred from a neighboring block. As shown in the example in FIG. 17, the DMVR process is applied to the neighboring blocks located at the position 0 and 2, and the DMVR process is not applied to the neighboring blocks located at the position 1 and 3.

When the current block is coded using the regular merge mode, the decision of the DMVR process can be inherited from a neighboring block corresponding to the merge candidate indicated by “merge_idx.” For example, when the current block is predicted using the regular merge mode with “merge_idx” equal to 3, the DMVR process is not applied to the current block, because block 3 in the example in FIG. 15 does not apply DMVR. In another example, when the current block is predicted using the regular merge mode with merge candidate 0, the DMVR process is applied to the current block, because block 0 in the example in FIG. 15 applies DMVR.

In some embodiments, the decision of whether the DMVR process can be applied to a current block predicted using CIIP mode is inferred from the neighboring block.

In some embodiments, the decision of whether the DMVR process can be applied to a current block predicted using regular merge mode or CIIP mode is inferred from the neighboring block.

DMVR on/off for regular merge mode and CIIP can be inherited, and an additional flag in the merge mode can be signaled to allow the opposite option.

This section is the combination of the signaling of one flag in merge mode to disable the DMVR process and the inheriting of DMVR decision for regular merge mode and CIIP mode. In some embodiments, the decision of the DMVR process can be inferred from the merge candidate and signal one additional flag to provide the opposite option of the DMVR process in the regular merge mode. In other words, if DMVR is turned off for a given merge candidate (e.g., merge candidate 0) in the regular merge mode, then in this alternative merge process, DMVR is turned on for a given merge candidate (e.g., merge candidate 0).

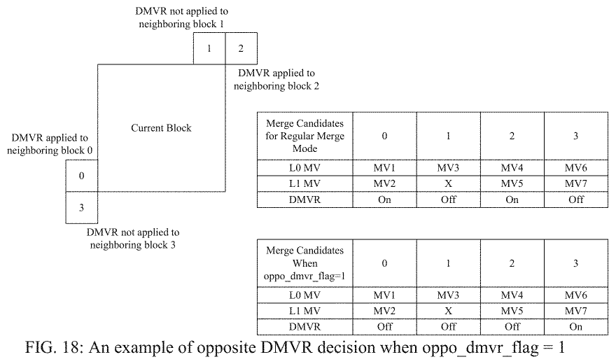

In some embodiments, the decision of whether the DMVR process is applied to a current block predicted using the regular merge mode is inferred from a neighboring block corresponding to the merge candidate indicated by “merge_idx.” And, one additional flag can be signaled before the CIIP mode to provide an opposite option for the current block in the alternative merge mode. As shown in FIG. 18, the DMVR process is applied to the neighboring blocks located at the position 0 and 2, and the DMVR process is not applied to the neighboring blocks located at the position 1 and 3.

When the current block is coded using the regular merge mode, the decision of the DMVR process is inherited from the neighboring block. For example, when the current block is predicted using the regular merge mode with “merge_idx” being equal to 3, the DMVR process is not applied to the current block.

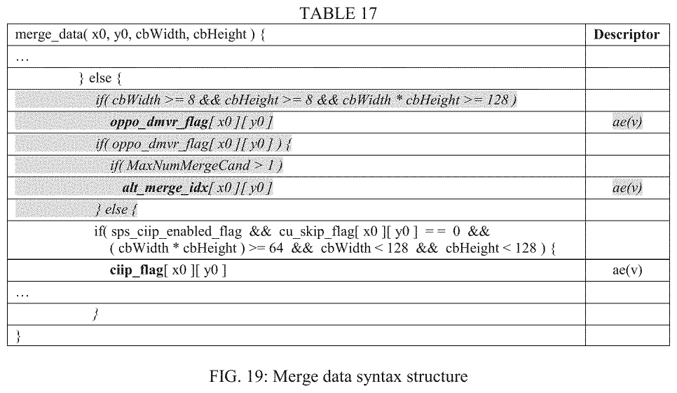

When the current block is not coded using the regular merge mode, an additional flag “oppo_dmvr_flag” can be signaled before the CIIP mode, as shown in Table 17 of FIG. 19. (emphasized in italics and gray). When the “oppo_dmvr_flag” is equal to 1, a merge index in an alternative merge candidate list can be signaled. The alternative merge candidate list can be derived from the list used in the regular merge mode. During the derivation, the motion information of each merge candidate can be directly reused but the DMVR decision can be set to the opposite of the corresponding merge candidate in the regular merge mode. As shown in FIG. 18, when the current block is predicted with the alternative merge mode and merge candidate 3 (i.e., oppo_dmvr_flag=1 and alt_merge_idx=3), the DMVR process can be applied to the current block. It is noted that during the derivation of the alternative merge candidate list, the uni-prediction can be converted to bi-prediction using the methods mentioned before.

Application of DMVR to the non-merge mode will be described below.

The DMVR process is adopted to VVC because it increases the coding performance by refining the bi-prediction motion vectors. However, in VVC draft 5, DMVR is only applied to a block predicted using the merge mode. In other words, DMVR is not applied to a block coded using the advance motion vector prediction (AMVP) mode or the symmetric motion vector difference (SMVD) mode. This can reduce the benefit of the DMVR process. Therefore, in some embodiments, the DMVR process can be applied to AMVP and SMVD mode.

Application of DMVR to the symmetric motion vector difference mode will be described below.

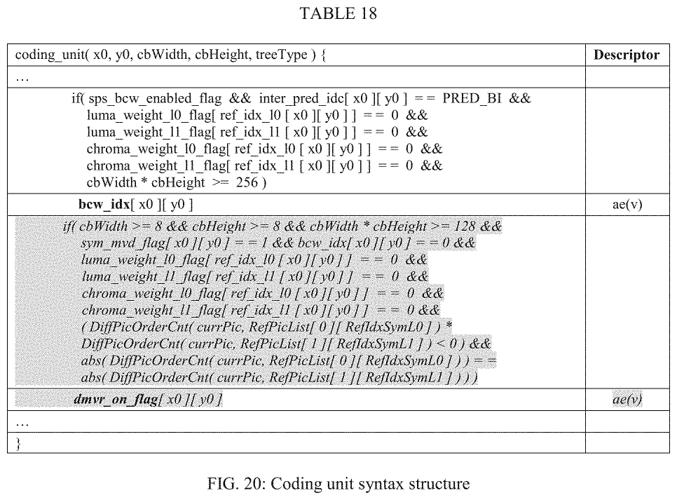

In some embodiments, the DMVR process can be applied to SMVD mode, as shown in Table 18 of FIG. 20 (emphasized in italics and gray). The syntax element “dmvr_on_flag” can be signaled after BWA index (i.e., the syntax element “bcw_idx”) to indicate whether the DMVR process is applied to SMVD mode. This flag is signaled when all the following conditions are satisfied:
The block has larger than or equal to 128 luma samples and the block width and height are both larger than or equal to 8 luma samples;
The block is predicted using the SMVD mode with BWA disabled;
The weighted prediction is disabled;
One reference picture is in the past and another reference picture is in the future with respect to the current picture; and
The distances (i.e. POC difference) from L0 and L1 reference pictures to the current picture are the same.

When the flag “dmvr_on_flag” is not present, the flag can be inferred to be 0. In other words, the DMVR process is not applied to the SMVD block.

In another embodiment, a flag is signaled after the SMVD mode, as shown in Table 19 of FIG. 20 (emphasized in italics and gray). The syntax element “dmvr_on_flag” is used to indicate whether the DMVR process is applied to the block. When the “dmvr_on_flag” is equal to 1, the BCW index is no longer signaled. In this case, the BCW index is inferred to be 0. In other words, equal weights are applied.

Application of DMVR to the advance motion vector prediction mode (AMVP) will be described below.

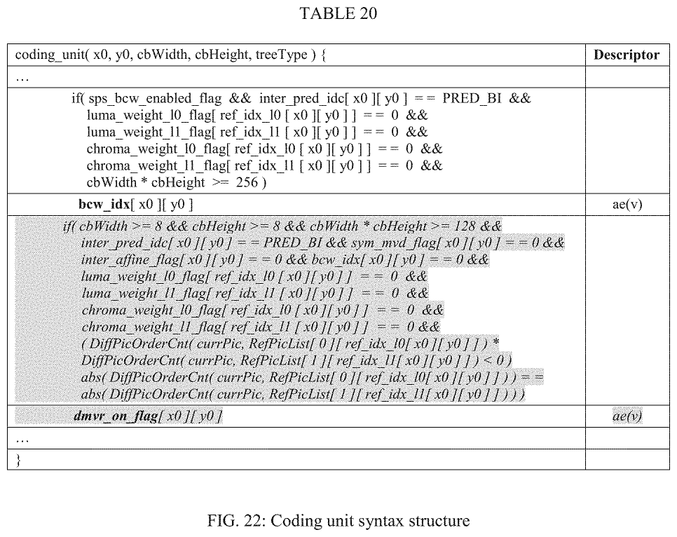

In some embodiments, the DMVR process is applied to AMVP mode, as shown in Table 20 of FIG. 22 (emphasized in italics and gray). The syntax element “dmvr_on_flag” is signaled after the BWA index (i.e., the syntax element “bcw_idx”) to indicate whether the DMVR process is applied to the AMVP mode. This flag is only signaled when all the following conditions are satisfied:
The block has larger than or equal to 128 luma samples and the block width and height are both larger than or equal to 8 luma samples;
The block is bi-predicted;
The block is predicted using the AMVP mode with BWA disabled. In other words, the block is not predicted using SMVD or affine mode;
The weighted prediction is disabled;
One reference picture is in the past and another reference picture is in the future with respect to the current picture;
The distances (i.e. POC difference) from L0 and L1 reference pictures to the current picture are the same.

When the flag “dmvr_on_flag” is not present, the flag is inferred to be 0. In other words, the DMVR process is disabled.

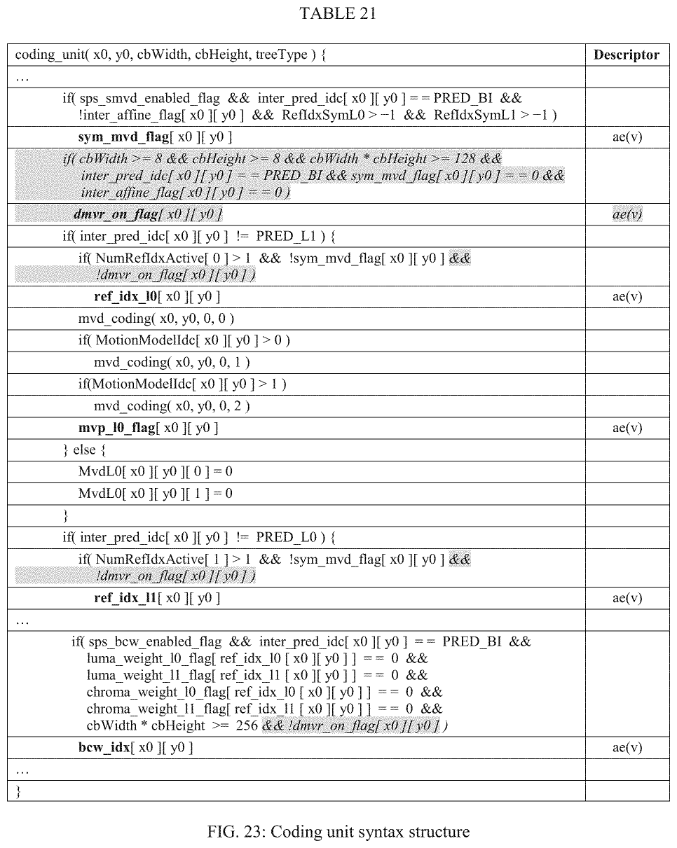

In some embodiments, a flag is signaled after the SMVD mode, as shown in Table 21 of FIG. 23 (emphasized in italics and gray). The syntax element “dmvr_on_flag” is used to indicate whether the DMVR process is applied to the block. When the “dmvr_on_flag” is equal to 1, the BCW index and the reference indices of L0 and L1 are both no longer signaled. In this case, the BCW index is inferred to be 0 (i.e., equal weights). The reference indices of L0 and L1 are set to be equal to a slice level pre-determined value.

As an example, the slice level pre-determined value of the reference indices of L0 and L1 can be equal to those for SMVD mode. In other words, the reference indices of L0 and L1 are set to be equal to RefIdxSymL0 and RefIdxSymL1, respectively.

As another example, the slice level pre-determined value of the reference indices of L0 and L1 are two indices that satisfy the following conditions:

1. One of the two reference pictures corresponding to the two reference indices is in the past, and the other one is in the future with respect to the current picture;

2. The distances from both reference pictures to the current picture are the same.

The above methods provided by the present disclosure may be used individually or jointly.

In some embodiments, a flag is signaled to indicate whether the DMVR process is applied to a block predicted using the AMVP mode or the SMVD mode. That is, the combination of the application of the DMVR to the symmetric motion vector difference mode and the application of the DMVR to the advance motion vector prediction mode.

In some embodiments, the decision of whether the DMVR process is applied to a block predicted using the regular merge mode can be inferred from the merge candidate signaled by “merge_idx.” Besides, a flag can be signaled to indicate whether the DMVR process is applied to a block predicted using the AMVP mode or the SMVD mode. That is, the combination of the inheriting of the DMVR decision for the regular merge mode and the CIIP mode, the application of the DMVR to the symmetric motion vector difference mode, and the application of the DMVR to the advance motion vector prediction mode.

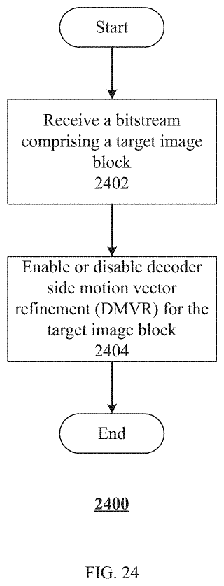

FIG. 24 illustrates a flowchart of a computer-implemented method 2400 for processing video content. In some embodiments, method 2400 can be performed by a codec (e.g., an encoder in FIGS. 2A-2B or a decoder in FIGS. 3A-3B). For example, the codec can be implemented as one or more software or hardware components of an apparatus (e.g., apparatus 400) for encoding or transcoding a video sequence. In some embodiments, the video sequence can be an uncompressed video sequence (e.g., video sequence 202) or a compressed video sequence that is decoded (e.g., video stream 304). In some embodiments, the video sequence can be a monitoring video sequence, which can be captured by a monitoring device (e.g., the video input device in FIG. 4) associated with a processor (e.g., processor 402) of the apparatus. The video sequence can include multiple pictures. The apparatus can perform method 2400 at the level of pictures. For example, the apparatus can process one picture at a time in method 2400. For another example, the apparatus can process a plurality of pictures at a time in method 2400. Method 2400 can include steps as below.

At step 2402, a bitstream comprising a target image block can be received. The bitstream can include a plurality of image blocks, and the image blocks can be prediction blocks of a picture.

At step 2404, decoder side motion vector refinement (DMVR) can be enabled or disabled for the target image block. The enabling or disabling is based on at least one of: a flag signaled in the bitstream, or whether the DMVR is enabled or disabled for a neighboring block of the target image block. The target image block can be coded using a regular merge mode, an advance motion vector prediction (AMVP) mode or a symmetric motion vector difference (SMVD) mode.

In some embodiments, when the target image block is coded using the AMVP mode or the SMVD mode, method 2400 can further include: enabling the DMVR for the target image block based on the flag signaled in the bitstream. And before enabling or disabling the DMVR for the target image block, determining that the target image block satisfies a first condition. For example, the first condition can include: the target image block including 128 or more luma samples; a width and a height of the target image block each being greater than or equal to 8 luma samples; the target image block being predicted using the SMVD mode with bi-prediction-with-weight-averaging (BWA) being disabled; weighted prediction being disabled for the target image block; the target image block being bi-predicted based on a previous reference picture and a future reference picture; and the previous reference picture and the future reference picture having same distance to a picture comprising the target image block.

In some embodiments, when the target image block is coded in a regular merge mode, the enabling or disabling of the DMVR for the target image block can include: disabling the DMVR for the target image block based on the flag signaled in the bitstream.

In some embodiments, when the target image block is coded in a combined inter and intra prediction (CIIP) mode, the enabling or disabling of the DMVR for the target image block can include: disabling the DMVR for the target image block based on the flag signaled in the bitstream.

In some embodiments, the enabling or disabling of the DMVR for the target image block can include: in response to the bitstream comprising the flag, enabling or disabling the DMVR for the target image block based on the flag; or in response to the flag being absent from the bitstream, enabling or disabling the DMVR for the target image block based on the whether the DMVR is enabled or disabled for a neighboring block of the target image block. For example, enabling or disabling the DMVR for the target image block based on the whether the DMVR is enabled or disabled for a neighboring block of the target image block can include: determining a merge candidate for predicting the target image block; determining whether the DMVR is enabled for the merge candidate; in response to the DMVR being enabled for the merge candidate, enabling the DMVR for the target image block; or in response to the DMVR being disabled for the merge candidate, disabling the DMVR for the target image block.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The embodiments may further be described using the following clauses:

1. A computer-implemented method for processing video content, comprising:

receiving a bitstream comprising a target image block; and

enabling or disabling decoder side motion vector refinement (DMVR) for the target image block, wherein the enabling or disabling is based on at least one of:
a flag signaled in the bitstream, or
whether the DMVR is enabled or disabled for a neighboring block of the target image block.

2. The method according to clause 1, wherein: the target image block is coded using an advance motion vector prediction (AMVP) mode or a symmetric motion vector difference (SMVD) mode, and

the enabling or disabling the DMVR for the target image block comprises:
enabling the DMVR for the target image block based on the flag signaled in the bitstream.

3. The method according to clause 2, further comprising:

before enabling or disabling the DMVR for the target image block, determining that the target image block satisfies a first condition.

4. The method according to clause 3, wherein the first condition comprises:

the target image block including 128 or more luma samples;

a width and a height of the target image block each being greater than or equal to 8 luma samples;

the target image block being predicted using the SMVD mode with bi-prediction-with-weight-averaging (BWA) being disabled;

weighted prediction being disabled for the target image block;

the target image block being bi-predicted based on a previous reference picture and a future reference picture; and

the previous reference picture and the future reference picture having same distance to a picture comprising the target image block.

5. The method according to any one of clauses 1-4, wherein:

the target image block is coded in a regular merge mode, and

the enabling or disabling of the DMVR for the target image block comprises:
disabling the DMVR for the target image block based on the flag signaled in the bitstream.

6. The method according to any one of clauses 1-5, wherein:

the target image block is coded in a combined inter and intra prediction (CIIP) mode, and

the enabling or disabling of the DMVR for the target image block comprises:
disabling the DMVR for the target image block based on the flag signaled in the bitstream.

7. The method according to any one of clauses 1-6, wherein the enabling or disabling of the DMVR for the target image block comprises:

in response to the bitstream comprising the flag, enabling or disabling the DMVR for the target image block based on the flag; or

in response to the flag being absent from the bitstream, enabling or disabling the DMVR for the target image block based on the whether the DMVR is enabled or disabled for a neighboring block of the target image block.

8. The method according to clause 7, wherein enabling or disabling the DMVR for the target image block based on whether the DMVR is enabled or disabled for a neighboring block of the target image block comprises:

determining a merge candidate for predicting the target image block;

determining whether the DMVR is enabled for the merge candidate;

in response to the DMVR being enabled for the merge candidate, enabling the DMVR for the target image block; or

in response to the DMVR being disabled for the merge candidate, disabling the DMVR for the target image block.

9. A system for processing video content, comprising:

a memory for storing a set of instructions; and

at least one processor configured to execute the set of instructions to cause the system to:
receive a bitstream comprising a target image block; and
enable or disable decoder side motion vector refinement (DMVR) for the target image block, wherein the enabling or disabling is based on at least one of:
a flag signaled in the bitstream, or
whether the DMVR is enabled or disabled for a neighboring block of the target image block.

10. The system according to clause 9, wherein: the target image block is coded using an advance motion vector prediction (AMVP) mode or a symmetric motion vector difference (SMVD) mode, and

in enabling or disabling the DMVR for the target image block, the at least one processor is configured to execute the set of instructions to further cause the system to:
enable the DMVR for the target image block based on the flag signaled in the bitstream.

11. The system according to clause 10, wherein the at least one processor is configured to execute the set of instructions to further cause the system to:

before enabling or disabling the DMVR for the target image block, determine that the target image block satisfies a first condition.

12. The system according to clause 11, wherein the first condition comprises:

the target image block including 128 or more luma samples;

a width and a height of the target image block each being greater than or equal to 8 luma samples;

the target image block being predicted using the SMVD mode with bi-prediction-with-weight-averaging (BWA) being disabled;

weighted prediction being disabled for the target image block;

the target image block being bi-predicted based on a previous reference picture and a future reference picture; and

the previous reference picture and the future reference picture having same distance to a picture comprising the target image block.

13. The system according to any one of clauses 9-12, wherein:

the target image block is coded in a regular merge mode, and

in enabling or disabling of the DMVR for the target image block, the at least one processor is configured to execute the set of instructions to further cause the system to:
disable the DMVR for the target image block based on the flag signaled in the bitstream.

14. The system according to any one of clauses 9-13, wherein:

the target image block is coded in a combined inter and intra prediction (CIIP) mode, and

in enabling or disabling of the DMVR for the target image block, the at least one processor is configured to execute the set of instructions to further cause the system to:
disable the DMVR for the target image block based on the flag signaled in the bitstream.

15. The system according to any one of clauses 9-14, wherein in enabling or disabling of the DMVR for the target image block, the at least one processor is configured to execute the set of instructions to further cause the system to:

in response to the bitstream comprising the flag, enable or disable the DMVR for the target image block based on the flag; or

in response to the flag being absent from the bitstream, enable or disable the DMVR for the target image block based on the whether the DMVR is enabled or disabled for a neighboring block of the target image block.

16. The system according to clause 15, wherein in enabling or disabling the DMVR for the target image block based on whether the DMVR is enabled or disabled for a neighboring block of the target image block, the at least one processor is configured to execute the set of instructions to further cause the system to:

determine a merge candidate for predicting the target image block;

determine whether the DMVR is enabled for the merge candidate;

in response to the DMVR being enabled for the merge candidate, enable the DMVR for the target image block; or

in response to the DMVR being disabled for the merge candidate, disable the DMVR for the target image block.

17. A non-transitory computer readable medium that stores a set of instructions that is executable by at least one processor of a computer system to cause the computer system to perform a method for processing video content, the method comprising:

receiving a bitstream comprising a target image block; and

enabling or disabling decoder side motion vector refinement (DMVR) for the target image block, wherein the enabling or disabling is based on at least one of:
a flag signaled in the bitstream, or
whether the DMVR is enabled or disabled for a neighboring block of the target image block.

18. The non-transitory computer readable medium according to clause 17, wherein: the target image block is coded using an advance motion vector prediction (AMVP) mode or a symmetric motion vector difference (SMVD) mode, and

the enabling or disabling the DMVR for the target image block comprises:
enabling the DMVR for the target image block based on the flag signaled in the bitstream.

19. The non-transitory computer readable medium according to clause 18, wherein the method further comprises:

before enabling or disabling the DMVR for the target image block, determining that the target image block satisfies a first condition.

20. The non-transitory computer readable medium according to clause 19, wherein the first condition comprises:

the target image block including 128 or more luma samples;

a width and a height of the target image block each being greater than or equal to 8 luma samples;

the target image block being predicted using the SMVD mode with bi-prediction-with-weight-averaging (BWA) being disabled;

weighted prediction being disabled for the target image block;

the target image block being bi-predicted based on a previous reference picture and a future reference picture; and

the previous reference picture and the future reference picture having same distance to a picture comprising the target image block.

21. A method for processing video content, comprising:

receiving a signal associated with a target merge block; and

in response to the signal indicating a first predetermined value, disabling a decoder side motion vector refinement (DMVR) process associated with the target merge block,

wherein the target merge block is predicted using a regular merge mode or a combined inter and intra predication (CIIP) mode.

22. The method according to clause 21, further comprising:

in response to the signal indicating a second predetermined value, enabling the DMVR process associated with the target merge block.

23. The method according to clause 22, further comprising:

determining whether the target merge block is predicted using a uni-prediction candidate; and

in response to the target merge block being predicted using the uni-prediction candidate, converting the uni-prediction candidate to a bi-prediction merge candidate when the signal indicates the second predetermined value.

24. A method for processing video content, comprising:

determining a neighboring block that corresponds to a merge candidate for predicting a first merge block in a regular merge mode or a combined inter and intra predication (CIIP) mode;

determining whether a decoder side motion vector refinement (DMVR) process is enabled or disabled for the neighboring block; and

in response to the DMVR process being disabled for the neighboring block, disabling the DMVR process for the first merge block.

25. The method according to clause 24, further comprising:

in response to the signal indicating a second predetermined value, enabling the DMVR process associated with the first merge block.

26. A method for processing video content, comprising:

determining a neighboring block that corresponds to a merge candidate for predicting a first merge block;

receiving a signal determining whether the first merge block is coded using a regular merge mode; and

enabling a decoder side motion vector refinement (DMVR) process on the first merge block based on the signal and the neighboring block.

27. The method according to clause 26, wherein enabling the DMVR process on the first merge block based on the signal and the neighboring block further comprising:

determining whether the DMVR is enabled on the neighboring block; and

in response to the determination that the first merge block is not coded using the regular merge mode and the determination that the DMVR is disabled on the neighboring block, enabling the DMVR process on the first merge block.

28. The method according clause 26 or 27, further comprising:

in response to the determination that the first merge block is not coded using the regular merge mode and the determination that the DMVR is enabled on the neighboring block, disabling the DMVR process on the first merge block.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A computer-implemented method for processing video content, comprising:
receiving a bitstream comprising a target image block; and
enabling or disabling decoder side motion vector refinement (DMVR) for the target image block, wherein the enabling or disabling is based on at least one of:
a flag signaled in the bitstream, or
whether the DMVR is enabled or disabled for a neighboring block of the target image block.

2. The method according to claim 1, wherein: the target image block is coded using an advance motion vector prediction (AMVP) mode or a symmetric motion vector difference (SMVD) mode, and
the enabling or disabling the DMVR for the target image block comprises:
enabling the DMVR for the target image block based on the flag signaled in the bitstream.

3. The method according to claim 2, further comprising:
before enabling or disabling the DMVR for the target image block, determining that the target image block satisfies a first condition.

4. The method according to claim 3, wherein the first condition comprises:
the target image block including 128 or more luma samples;
a width and a height of the target image block each being greater than or equal to 8 luma samples;
the target image block being predicted using the SMVD mode with bi-prediction-with-weight-averaging (BWA) being disabled;
weighted prediction being disabled for the target image block;
the target image block being bi-predicted based on a previous reference picture and a future reference picture; and
the previous reference picture and the future reference picture having same distance to a picture comprising the target image block.

5. The method according to claim 1, wherein:
the target image block is coded in a regular merge mode, and
the enabling or disabling of the DMVR for the target image block comprises:
disabling the DMVR for the target image block based on the flag signaled in the bitstream.

6. The method according to claim 1, wherein:
the target image block is coded in a combined inter and intra prediction (CIIP) mode, and
the enabling or disabling of the DMVR for the target image block comprises:
disabling the DMVR for the target image block based on the flag signaled in the bitstream.

7. The method according to claim 1, wherein the enabling or disabling of the DMVR for the target image block comprises:
in response to the bitstream comprising the flag, enabling or disabling the DMVR for the target image block based on the flag; or
in response to the flag being absent from the bitstream, enabling or disabling the DMVR for the target image block based on the whether the DMVR is enabled or disabled for a neighboring block of the target image block.

8. The method according to claim 7, wherein enabling or disabling the DMVR for the target image block based on whether the DMVR is enabled or disabled for a neighboring block of the target image block comprises:
determining a merge candidate for predicting the target image block;
determining whether the DMVR is enabled for the merge candidate;
in response to the DMVR being enabled for the merge candidate, enabling the DMVR for the target image block; or
in response to the DMVR being disabled for the merge candidate, disabling the DMVR for the target image block.

9. A system for processing video content, comprising:
a memory for storing a set of instructions; and
at least one processor configured to execute the set of instructions to cause the system to:
receive a bitstream comprising a target image block; and
enable or disable decoder side motion vector refinement (DMVR) for the target image block, wherein the enabling or disabling is based on at least one of:
a flag signaled in the bitstream, or
whether the DMVR is enabled or disabled for a neighboring block of the target image block.

10. The system according to claim 9, wherein: the target image block is coded using an advance motion vector prediction (AMVP) mode or a symmetric motion vector difference (SMVD) mode, and
in enabling or disabling the DMVR for the target image block, the at least one processor is configured to execute the set of instructions to further cause the system to:
enable the DMVR for the target image block based on the flag signaled in the bitstream.

11. The system according to claim 10, wherein the at least one processor is configured to execute the set of instructions to further cause the system to:
before enabling or disabling the DMVR for the target image block, determine that the target image block satisfies a first condition.

12. The system according to claim 11, wherein the first condition comprises:
the target image block including 128 or more luma samples;
a width and a height of the target image block each being greater than or equal to 8 luma samples;
the target image block being predicted using the SMVD mode with bi-prediction-with-weight-averaging (BWA) being disabled;
weighted prediction being disabled for the target image block;
the target image block being bi-predicted based on a previous reference picture and a future reference picture; and
the previous reference picture and the future reference picture having same distance to a picture comprising the target image block.

13. The system according to claim 9, wherein:
the target image block is coded in a regular merge mode, and
in enabling or disabling of the DMVR for the target image block, the at least one processor is configured to execute the set of instructions to further cause the system to:
disable the DMVR for the target image block based on the flag signaled in the bitstream.

14. The system according to claim 9, wherein:
the target image block is coded in a combined inter and intra prediction (CIIP) mode, and
in enabling or disabling of the DMVR for the target image block, the at least one processor is configured to execute the set of instructions to further cause the system to:
disable the DMVR for the target image block based on the flag signaled in the bitstream.

15. The system according to claim 9, wherein in enabling or disabling of the DMVR for the target image block, the at least one processor is configured to execute the set of instructions to further cause the system to:
in response to the bitstream comprising the flag, enable or disable the DMVR for the target image block based on the flag; or
in response to the flag being absent from the bitstream, enable or disable the DMVR for the target image block based on the whether the DMVR is enabled or disabled for a neighboring block of the target image block.

16. The system according to claim 15, wherein in enabling or disabling the DMVR for the target image block based on whether the DMVR is enabled or disabled for a neighboring block of the target image block, the at least one processor is configured to execute the set of instructions to further cause the system to:
determine a merge candidate for predicting the target image block;
determine whether the DMVR is enabled for the merge candidate;
in response to the DMVR being enabled for the merge candidate, enable the DMVR for the target image block; or
in response to the DMVR being disabled for the merge candidate, disable the DMVR for the target image block.

17. A non-transitory computer readable medium that stores a set of instructions that is executable by at least one processor of a computer system to cause the computer system to perform a method for processing video content, the method comprising:
receiving a bitstream comprising a target image block; and
enabling or disabling decoder side motion vector refinement (DMVR) for the target image block, wherein the enabling or disabling is based on at least one of:
a flag signaled in the bitstream, or
whether the DMVR is enabled or disabled for a neighboring block of the target image block.

18. The non-transitory computer readable medium according to claim 17, wherein: the target image block is coded using an advance motion vector prediction (AMVP) mode or a symmetric motion vector difference (SMVD) mode, and
the enabling or disabling the DMVR for the target image block comprises:
enabling the DMVR for the target image block based on the flag signaled in the bitstream.

19. The non-transitory computer readable medium according to claim 18, wherein the method further comprises:
before enabling or disabling the DMVR for the target image block, determining that the target image block satisfies a first condition.

20. The non-transitory computer readable medium according to claim 19, wherein the first condition comprises:
the target image block including 128 or more luma samples;
a width and a height of the target image block each being greater than or equal to 8 luma samples;
the target image block being predicted using the SMVD mode with bi-prediction-with-weight-averaging (BWA) being disabled;
weighted prediction being disabled for the target image block;
the target image block being bi-predicted based on a previous reference picture and a future reference picture; and
the previous reference picture and the future reference picture having same distance to a picture comprising the target image block.
